(19) United States
(12) Patent Application Publication
(10) Pub. No.: US 2004/0001677 A1
(43) Pub. Date: Jan. 1, 2004

(54) Telescopic collimator and method of manufacture

(76) Inventors: John P. Kondis, Costa Mesa, CA (US); Bradley A. Scott, Silverado, CA (US); Donald J. Wissuchek JR., Los Alamitos, CA (US)

Correspondence Address: CORNING INCORPORATED, SP-TI-3-1, CORNING, NY, 14831

(21) Appl. No.: 10/405,670

(22) Filed: Apr. 1, 2003

Related U.S. Application Data
(60) Provisional application No. 60/374,942, filed on Apr. 23, 2002.

(51) Int. Cl. G02B 6/36

(52) U.S. Cl. 385/93; 385/115; 385/119

(57) ABSTRACT

A multi-fiber optical collimator includes a plurality of optical fibers for carrying optical signals, a first lens and a beam expander. The first lens has first and second sides and a first focal length. The first side of the first lens is positioned a distance of about the first focal length from first ends of the optical fibers. The beam expander has first and second sides and the first side of the beam expander is positioned to face the second side of the first lens. The second side of the beam expander provides collimated beams associated with the optical signals carried by the optical fibers.

This application claims the benefit of U.S. Provisional Patent Application Serial No. 60/374,942, filed Apr. 23, 2002, the entire disclosure of which is hereby incorporated herein by reference.

### BACKGROUND OF THE INVENTION

1. Field of the Invention

The present invention is generally directed to a collimator and, more specifically, a telescopic collimator and method of manufacturing a telescopic collimator.

2.Technical Background

When packaging optical systems, it is often advantageous to use multiple inputs and outputs that are coupled to the same main optical platform to minimize component costs. For many applications, this can be accomplished by using dual or multiple fiber collimators as signal input and output elements. With reference to FIG. 1, a multiple beam collimator 100 consists of multiple fibers 102, 104 and 106, whose facets 102A, 104A and 106A, respectively, are positioned at a distance of approximately one focal length “f” from a collimating lens 108.

For the collimator 100, an exit pupil 110, i.e., the point at which the collimated beams share a common or nearly common physical aperture, is located at a distance of approximately one focal length “f” from the collimating lens 108. For many types of optical systems, it is desirable that the exit pupil 110 of the collimator 100 be co-located with the entrance pupil of an associated optical system to maximize signal coupling. A working distance (WD) of such a multi-beam collimator can be defined as the distance from the collimating lens to the exit pupil. A major disadvantage of traditional multi-beam collimators is that their WD is strongly correlated to the beam size that they produce.

Consequently, traditional multi-beam collimators with long WDs produce large beams, which result in sub-optimal designs for many optical systems, due to the fact that signal coupling may be adversely affected.

There is a need for a multi-fiber optical collimator that is designed to maximize signal coupling to components of an optical system while providing a relatively long working distance.

### SUMMARY OF THE INVENTION

An embodiment of the present invention is directed to a multi-fiber optical collimator that includes a plurality of optical fibers for carrying optical signals, a first lens and a beam expander. The first lens has first and second sides and a first focal length. The first side of the first lens is positioned a distance of about the first focal length from first ends of the optical fibers. The beam expander has first and second sides and the first side of the beam expander is positioned to face the second side of the first lens. The second side of the beam expander provides collimated beams associated with the optical signals carried by the optical fibers.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description, serve to explain the principals and operation of the invention.

### BRIEF DESCRIPTION OF THE DRAWINGS

FIG. 1 is a schematic view of a traditional multi-beam collimator, according to the prior art;

FIG. 2 is a schematic view of a telecentric optical system;

FIG. 3 is a schematic view of a telescopic collimator, according to an embodiment of the present invention;

FIG. 4 is a schematic view of a telescopic collimator, according to another embodiment of the present invention;

FIG. 5 is a schematic view of a telescopic collimator, according to still another embodiment of the present invention;

FIG. 6 is a schematic view of a dual fiber telescopic collimator, according to yet another embodiment of the present invention;

FIG. 7 is a schematic view showing the orientation of various components of the telescopic collimator of FIG. 6;

FIG. 8 is a schematic view showing the orientation of some components of the telescopic collimator of FIG. 6;

FIG. 9 is a schematic view of an optical feedback system for alignment of the components of the telescopic collimator of FIG. 6;

FIG. 10 is a schematic view of a dynamic spectrum equalizer (DSE) that incorporates a telescopic collimator, constructed according to the present invention;

FIG. 11 is a schematic view of another DSE that incorporates a telescopic collimator, constructed according to the present invention; and

FIG. 12 is a schematic view of yet another dynamic spectrum equalizer (DSE) that incorporates a telescopic collimator, constructed according to the present invention.

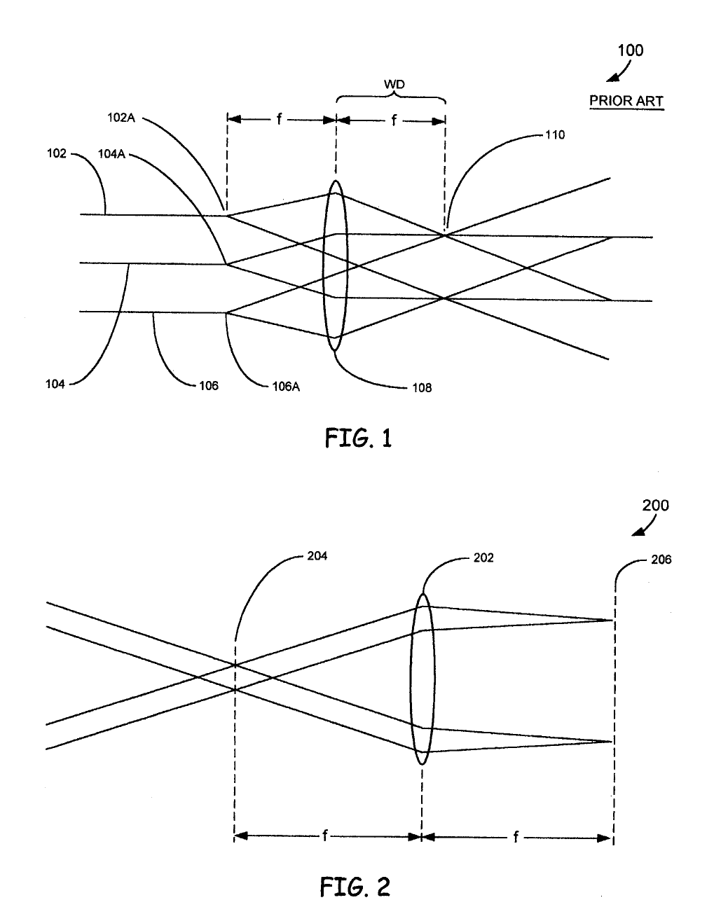

### DETAILED DESCRIPTION OF THE PREFERRED EMBODIMENT

Collimators that produce multiple collimated beams with small to moderate beam waist and long working distances (WDs) are highly desirable as the input component for many types of devices. Telescopic collimators are particularly useful as input/output elements for systems that utilize telecentric optical designs. FIG. 2 shows a schematic view of an exemplary telecentric optical system 200 including a collimating lens 202 with a telecentric stop 204 located one focal length “f” in front of the lens 202 and an image plane 206 formed one focal length “f” behind the lens 202. Telecentric optical systems have the key properties that an image height at the focal plane is substantially equal to the effective focal length (EFL) times the angle of incidence at the focusing lens and that the chief rays for the focused bundles are substantially parallel to each other. When a telescopic collimator is used with a telecentric optical system, light can be retroreflected with high coupling efficiency from the image plane 206 back into each of the input fibers, independently, such that each fiber of the telescopic collimator acts as an input and output for an independent optical path. This optical configuration is useful in a broad range of applications. It should also be appreciated that telescopic collimators can be used in non-telecentric optical systems. In such systems, it is often advantageous to design the optics, such that fibers are coupled to each other in pairs. In this configuration, each input fiber has a corresponding fiber to which it is optically coupled and that acts as its output fiber.

Specific devices for which telescopic collimators are desirable components include, for example, co-packaged dynamic spectrum equalizers (DSEs), co-packaged wavelength selective switches (WSSs), co-packaged dynamic gain flattening filters (DGFFs), multiport wavelength selective switches (MWSSs) and wavelength selective cross-connects (WSXCs). In general, “telescopic collimators,” described herein, enable a working distance (WD) and beam size to be controlled with greater flexibility than with traditional collimators.

In many optical systems, dynamic spectrum equalizers (DSEs) provide valuable functionality to optical network applications by providing the ability to access and modify individual wavelengths that are being carried in optical fibers, without using discrete wavelength division multiplexers (WDMs). Because more than one DSE is often used at a single node and the internal components of a DSE have substantial cost, it is of significant value to be able to co-package multiple DSEs in a manner such that they can share many internal optical components. According to embodiments of the present invention, a multiple path DSE implements a telescopic collimator constructed according to the present invention.

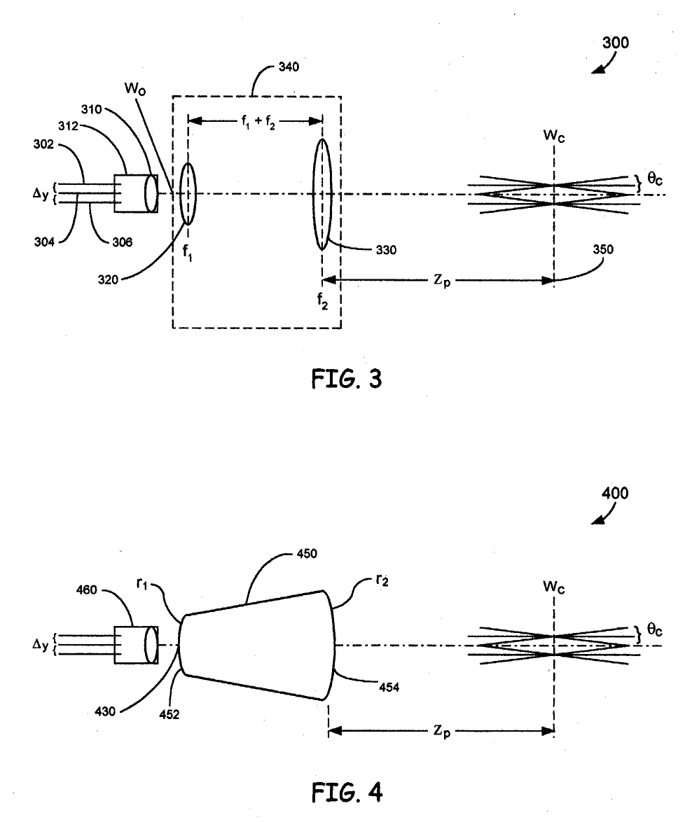

FIG. 3 shows a schematic view of an exemplary telescopic collimator 300 that includes a plurality of optical fibers 302, 304 and 306, a first lens 310 with a focal length f₀, positioned approximately one focal length from the facets of the optical fibers 302-306. A second lens 320, with a focal length f₁, is positioned at a distance of approximately f₀ from the first lens 310 and a third lens 330, with a focal length f₂, is positioned at a distance of approximately (f₁+f₂) from the second lens 320. While the collimator 300, as depicted in FIG. 3, includes three optical fibers 302-306, it should be appreciated that more or less optical fibers may be implemented in a telescopic collimator constructed according to the present invention.

The basic design, depicted in FIG. 3, includes a traditional multi-beam collimator 312 and a two lens telescope or beam expander 340. Using small angle approximations, the beam waist (w_{c}) of the collimated beams at the exit pupil 350 are given by w_{c}=M*w₀=(f₂/f₁)*w₀, where w₀ is the beam waist of the first lens 310, M is the magnification provided by lenses 320 and 330 and * is the multiplication symbol. The working distance, zₚ, is given by zₚ=(f₂+f₁)*M, where the second lens 320 (whose focal length is f₁) is in the front focal plane of the first lens 310, i.e., the distance between the first lens 310 and the second lens 320 is f₀. It should be appreciated that designs that position the second lens 320 at a distance other than f₀ from the first lens 310 require a different equation to predict the working distance zₚ. The angular separation of the beams at the exit pupil, θ_{c}, is given by θ_{c}=Δy/(M*f₀). In practice, multi-beam collimators with a beam waist radius of 184 microns and Δy of 125 μm are commonly available and working distances of approximately 100 mm with w_{c} of approximately 1.25 mm provide useful input beam characteristics for a wide range of optical devices. For these constraints, a second lens 320 with a focal length f₁ of 1.88 mm and a third lens 330 with a focal length f₂ of 12.8 mm supports desired output beam characteristics while producing a θ_{c of}0.54°. This results in a relatively small collimator that produces output beams with attractive characteristics and a long working distance (WD).

Using these criteria, custom collimator designs can be developed that are tailored for a broad range of applications. It should be appreciated that it is not a requirement of this basic design that the output beams of the first lens 310 be collimated to a high degree. It should also be appreciated that placement of the second lens 320 at a distance of approximately f₀ from the first lens 310 is not a requirement of this basic design. Further, a wide variety of focusing elements can provide the functionality of the first, second and third lenses 310, 320 and 330, respectively. Such focusing elements include, but are not limited to, spherical singlet lenses, aspheric singlet lenses, multiple element lenses, spherical mirrors, aspherical mirrors, graded-index (GRIN) lenses, Gradium® lenses and Mangan mirrors. This design is flexible and has many degrees of freedom for optimizing performance for a variety of applications. While dual fiber telescopic collimators can be produced using this approach, this design is particularly useful for applications that require more than two input beams. It should be appreciated that the equations set forth above may require modifications when small angle approximations are inappropriate.

The same basic principles that are used in the design shown in FIG. 3 can be used to design telescopic collimators that have fewer components. Such an embodiment is shown in FIG. 4. A two element telescopic collimator 400, shown in FIG. 4, includes a traditional multi-beam collimator 460 and a single lens element 450 with a first surface 452 having a radius r₁ and a second surface 454 with a radius r₂ with the first surface 452 located at approximately an exit pupil 430 of the traditional multi-beam collimator 460. The collimated beams from the collimator 460 pass through an intermediate focus within the single lens element 450. Using the same principles as described in the embodiment of FIG. 3, one skilled in the art can design telescopic collimators that satisfy a broad range of applications. For some applications, this embodiment may provide results that are superior to those provided by the embodiment of FIG. 3.

FIG. 5 shows a schematic view of an alternative two-element telescopic collimator 500. As shown, the collimator 500 utilizes a GRIN lens for first lens 520 and a molded aspheric lens for second lens 530. A pair of optical fibers 502 and 504 are retained within a ferrule 550, which is positioned with respect to the lens 520 within a first housing 560. The relationship of the second lens 530 and the first housing 560 are fixed within housing 540. It should be appreciated that other types of focusing elements, e.g., Gradium® lenses, spherical lenses and spherical mirrors, can also be used with this embodiment. Using this design, the general principles of the embodiment of FIG. 3 and standard optical design software, such as ZEMAX™ or CODE V™, one skilled in the art can design telescopic collimators that satisfy a broad range of applications. An advantage of this design over the design shown in FIG. 4 is simplicity of the components.

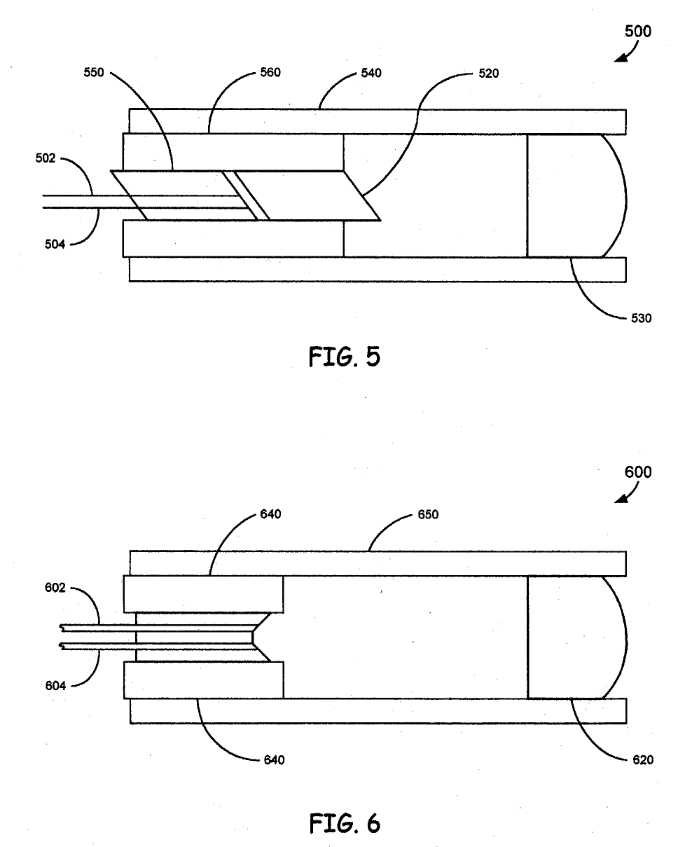

FIG. 6 depicts a schematic view of a telescopic collimator 600 that includes a single lens 620 and a plurality of input fibers 602 and 604 retained within ferrules 640, which are, in turn, retained within cylindrical housing 650. As with the designs shown in FIGS. 4 and 5, this embodiment has less design freedom than the embodiment shown in FIG. 3, but provides an attractive solution for dual fiber telescopic collimators. The schematic view shows an aspheric lens, but other focusing elements can also be used with this approach, e.g., spherical lens, spherical mirror, aspheric mirror and GRIN lens.

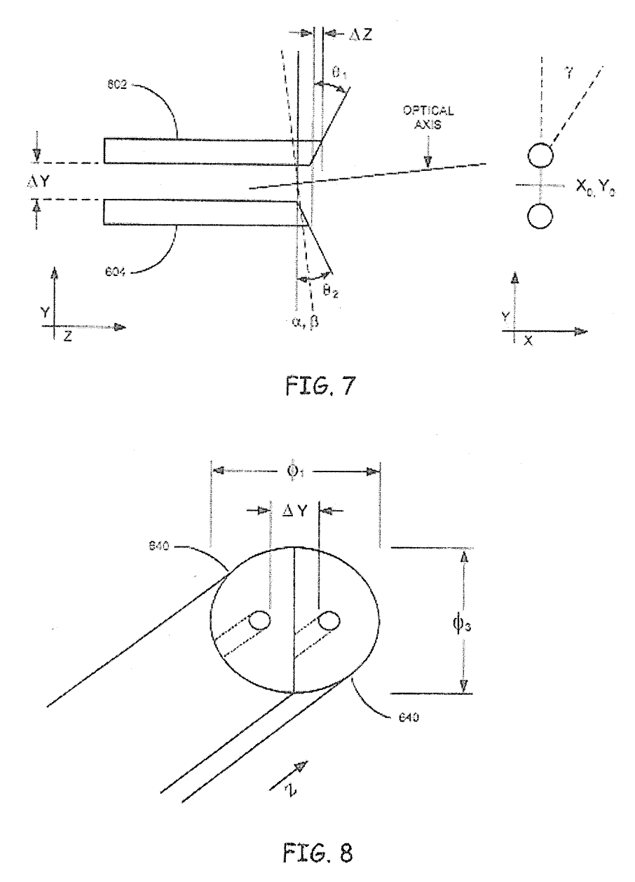

Using the same basic principles as described for the embodiment of FIG. 3, the beam waist of the output collimated beams is a function of the mode field radius of optical fibers 602 and 604 and the focal length of the lens 620. The relative angle of the output beams is a function of the separation of the fibers 602 and 604 and the focal length of the lens 620 and working distance (WD) is a function of the facet angles of the fibers 602 and 604, the focal length of the lens 620 and the separation of the fibers 602 and 604. In the one embodiment, the facet angles of the fibers 602 and 604 are equal in magnitude and aligned anti-parallel to each other (see FIG. 7).

The embodiment shown in FIG. 6 may be implemented with a molded aspheric lens with an effective focal length (EFL) of approximately 12.5 mm (e.g., Hoya part number A135, available from Hoya Corporation USA, 101 Metro Drive, Suite 500, San Jose, Calif. 95110) and two optical fibers polished with a facet angle of 8 degrees, separated by 200 microns and aligned as shown in FIG. 7.

According to another embodiment of the present invention, a method for manufacturing a dual fiber telescopic collimator is disclosed. This manufacturing method controls most of the key alignment parameters through component specification that allows many of the components to be assembled without alignment and generally reduces the alignment complexity to a single degree of freedom, i.e., Z-axis alignment of the fiber pair.

FIGS. 7 and 8 are schematic views showing a dual fiber telescopic collimator and the orientation of its internal optical fibers. During the manufacture of this collimator, the following parameters are controlled:

Z, the distance along the optical axis of the fiber pair from the lens;

ΔZ, the relative position of the two fibers along the optical axis direction, which should be minimized to near 0;

ΔY, the relative distance between the fibers in the plane perpendicular to the optical axis;

θ₁, θ₂, the facet angles of the fibers;

α, β, the angles of the nominal fiber planes, relative to the plane perpendicular to the optical axis;

X₀, Y₀, the position of the central point of the fiber pair relative to the optical axis; and

γ, the relative angle between the faceted surfaces of the fiber pair. According to an embodiment of the present invention, all of the above parameters, except for “Z,” are maintained by manufacturing tolerances on the components.

FIG. 8 shows a schematic view of an assembly that includes two D-shaped ferrules 640. An optical fiber 602 and 604 is assembled into each ferrule 640. The fibers and ferrules are polished with the desired facet angles, θ₁ and θ₂, which are controlled relative to the flat edge of the ferrule 640. During assembly, the flat edges of the two ferrules are registered to each other, such that the value ΔY is controlled through the manufacturing tolerances of the ferrules 640, and such that γ is minimized and bounded by the tolerances maintained during the polishing operation. This registration may be by direct contact, a controlled bond thickness, spacers or other means of registration. Ultimately, the pair of ferrules 640 and the lens 620 are assembled into a cylindrical housing 650, such that X₀, Y₀, α and β are controlled by the outer diameters, θ₃ and θ₁, of the fiber ferrules 640 and the positioning of the fibers 602 and 604 within the ferrules 640 (see FIG. 6). Additionally, when the relative position of the two D-shaped ferrules 640 becomes fixed (through bonding, for example), ΔZ can be established by registration against a flat surface or alternatively, by bringing both fibers into a co-incident focus on a high-magnification microscope. It is recognized that this registration may be performed before or after insertion of the ferrules 640 into the housing 650.

Through the steps described above, all key alignment parameters of the dual fiber telescopic collimator, except for “Z,” can be controlled through manufacturing tolerances and assembly may be achieved by processes that do not require feedback. However, in certain situations, the positioning of the ferrule pair to establish the parameter “Z” is achieved by alignment with optical feedback. It should be recognized that the appropriate dimensions can also be obtained by machining and polishing the facet angles θ₁ and θ₂ onto a monolithic cylindrical dual fiber ferrule with fibers fixed into capillaries at a separation of ΔY.

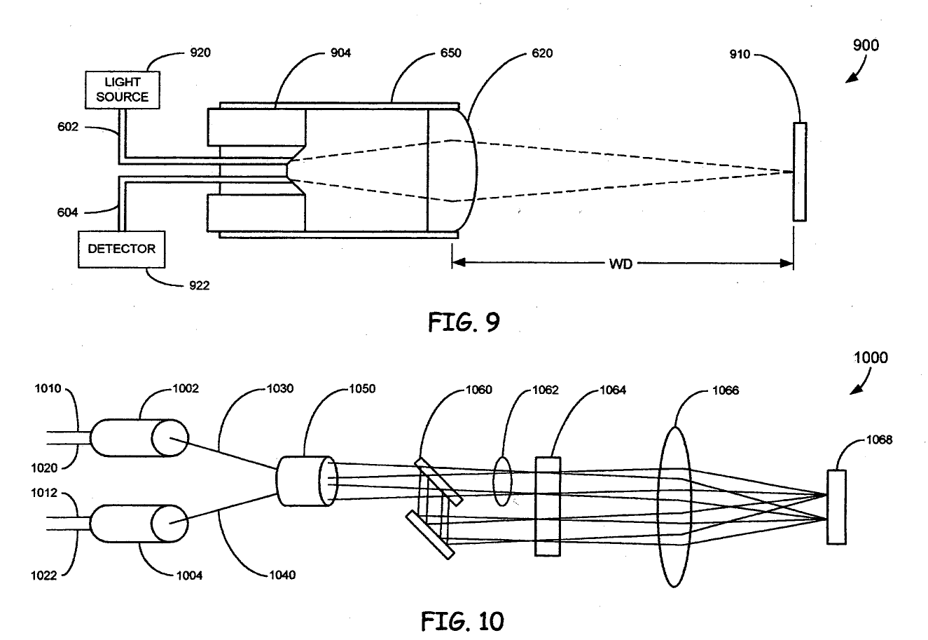

FIG. 9 illustrates an optical schematic view of a feedback system 900 for final alignment of the ferrule pair 904 (including two ferrules 640). In this embodiment, the fiber 602 is connected to a light source 920 and the fiber 604 is connected to an optical detector 922. The ferrule pair 904 is moved in and out of the collimator housing 650 until the power incident on the detector 922 is maximized. At this point, “Z” is optimized and the ferrule pair 904 position, relative to the lens 620, is fixed in place. This can be achieved by, for example, bonding, welding or mechanical fastening the ferrule pair 904 to the housing 650.

For some applications, manufacturing tolerances may be insufficient to guarantee ΔZ values that are acceptably low. This is often the case for dual fiber telescopic collimators that are used in conjunction with telecentric optical systems. In this case, the Z-position of each fiber 602 and 604 may be aligned after assembly into the collimator housing 650. In this case, the ferrule pair 904 is moved until maximum coupling between the fibers 602 and 604 is achieved. The mirror 910 is then tilted until maximum coupling is achieved for the fiber 602. The fiber 602 is then moved independently of fiber 604 until its coupling has been maximized. The mirror 910 is then tilted until maximum coupling for fiber 604 is achieved. The fiber 604 is then moved independently of the fiber 602 until coupling is maximized. The mirror 910 is then returned to its nominal position to verify that high coupling is still achieved between the fibers 602 and 604. This typically results in near optimal alignment for dual fiber telescopic collimators that are intended for use in conjunction with telecentric optical systems. It is contemplated that the housing 650 may be tilted, rather than the mirror 910, to achieve the same effect. It is also contemplated that more than one iteration may be necessary to achieve ideal alignment.

FIG. 10 depicts a schematic view of one embodiment of a DSE 1000 incorporating a telescopic collimator 1050, constructed according to an embodiment of the present invention. For clarity, the schematic view shows a dual DSE. However, it should be understood that an arbitrary number of DSEs may be co-packaged together using this design. For instance, to co-package four DSEs, the above design may be used with a four beam telescopic collimator and four circulators, one on each fiber of the telescopic collimator.

The DSE 1000 includes a plurality of circulators 1002 and 1004, a plurality of input fibers 1010 and 1012, output fibers 1020 and 1022, common fibers 1030 and 1040 (associated with the circulators 1002 and 1004), and a telescopic collimator 1050 with a plurality of input/output fibers that correspond to the plurality of circulator common fibers 1030 and 1040, which are spliced or otherwise optically coupled thereto. The DSE 1000 also includes a polarization beam separator 1060, a retarder or polarization rotator 1062, a wavelength dispersing element 1064, a lens 1066 and a reflective spatial light modulator (SLM) 1068. The input signals pass from the plurality of input fibers 1010 and 1012 into the plurality of circulators 1002 and 1004, respectively. The circulators 1002 and 1004 transmit the optical signals to the common fibers 1030 and 1040, respectively, without substantial leakage into the output fibers. The optical signals on the common fibers 1030 and 1040 are substantially collimated by the collimator 1050 and the polarization beam separator 1060 separates these collimated beams into pairs of polarized beamlets with polarizations that are substantially orthogonal to each other.

The retarder or polarization rotator 1062 is disposed in the path of one set of beamlets and converts their polarizations, such that they are substantially the same as the polarizations of the second set of beamlets. The beamlet sets are incident on the dispersing element 1064 and the output of the dispersing element 1064 provides a plurality of sets of beamlets, whose propagation directions are dependent on their wavelengths. The lens 1066 focuses these beamlets, such that they are separated spatially at the SLM 1068 and such that their focus is substantially coincidental with the reflective surface of the SLM 1068. The spatial separation of these beamlets is such that a plurality of pixel rows on the SLM 1068 have a one to one correspondence with the input/output fibers of the telescopic collimator 1050 and such that individual pixels within these rows can be used to define wavelength channels. The SLM 1068 modulates each of the beamlets so that its proportional power after collection at the output fiber is the desired value. The reflected light passes through the lens 1066 where it is redirected toward the dispersing element 1064. The dispersing element 1064 recombines the two series of beamlets into two output beamlets, which contain the'signal from the input beamlet. One of the beamlets passes through the retarder or polarization rotator 1062, which converts its polarization so that it is substantially orthogonal to the other beamlet. The polarization beam separator 1060 recombines the two beams and the collimator 1050 focuses the recombined beam into the common fibers 1030 and 1040. The circulators 1002 and 1004 then transmit the collected beams to the output fibers 1020 and 1022 without substantial leakage into the input fibers 1010 and 1012.

The polarization beam separator 1060 is shown as a pair of beam polarizing beamsplitters, but other polarization beam separators, including, but not limited to, birefringent plates, polarizing prisms and polarization beamsplitting slabs can be used. It should be understood that the polarizations can be separated in the same plane as the dispersion of the dispersing element or in a plane perpendicular to the dispersion of the dispersing element. The retarder or polarization rotator 1062 can be, for example, a retardation plate, a crystal rotator or a liquid crystal. Reflective SLMs that can be used in this device include, but are not limited to, reflective LCDs, pixellated birefringent crystal arrays, micro-electro-mechanical (MEMs) devices and arrays of variable filters. The dispersing element 1064 can be, but is not limited to, a grating, prism or grism.

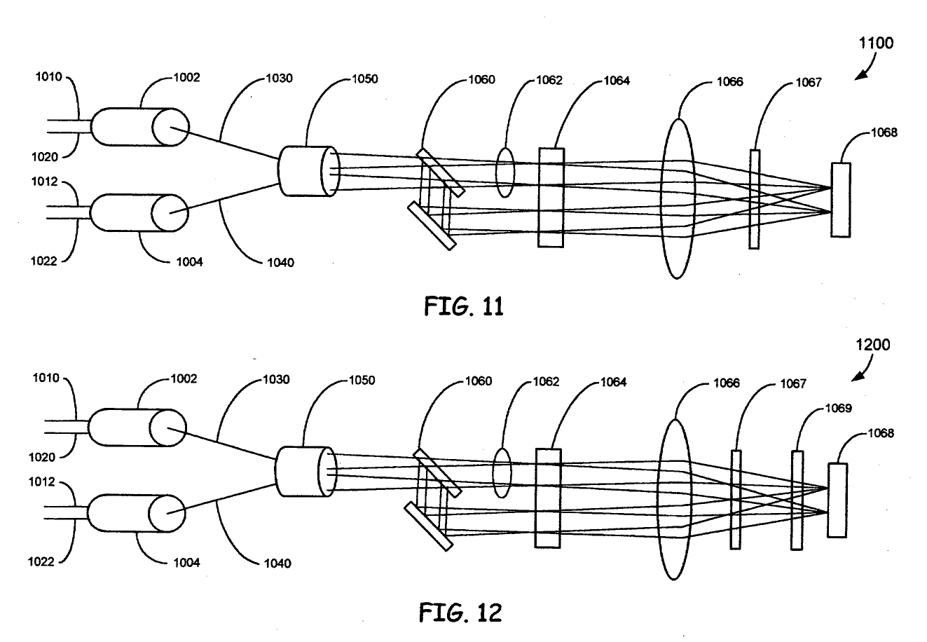

For many applications, it is desirable to have a DSE that can achieve very high extinction blocking (e.g., 35 dB or higher), so that it can block portions of the optical spectrum to a high degree. In practice, limitations on the quality of the components available for the approach illustrated in FIG. 10 often prevent achieving very high extinction when reflective polarization modulators are used as the SLM. FIG. 11 shows a high extinction, extremely low polarization dependence DSE 1100 that uses a polarization modulator as the SLM. This approach functions the same as the approach described in the embodiment of FIG. 10, except that an additional polarizer 1067 has been added between the lens 1066 and the SLM 1068. It is recognized that this polarizer can be placed anywhere between the retarder or polarization rotator 1062 and the SLM 1068. The polarizer 1067 serves to increase the polarization purity of the input beam to the SLM 1068 and to improve the polarization filtering of the output beam from the SLM 1068. The polarizer 1067 can be, but is not limited to, a polarizing prism, polymer linear polarizer, POLARCOR® linear polarizer or one or more Brewster plates. The reflective polarization modulator can be, but is not limited to, a reflective LCD or a pixellated birefringent crystal array.

FIG. 12 is a schematic view of a DSE 1200 that implements a telescopic collimator that enables a plurality of DSEs to be co-packaged and enables very high extinction when an LCD or other SLM has birefringent reflections at material interfaces. For applications that require extinction ratios much greater than 35 dB, the phase effects introduced by birefringent reflections typically prevent sufficient extinction from being achieved. The design in FIG. 12 is identical to the design in FIG. 11, except that there is an additional retarder 1069 disposed between the polarizer 1067 and the SLM 1068. In the preferred embodiment, the value of this retarder is (¼ wave)—(the residual birefringence of the LCD at the desired operating voltage). However, it is recognized that other retarder values can be used and the benefit of increased extinction will still be achieved.

The above-described embodiment may be implemented using Corning SMF-28 fibers as the plurality of input, output and common fibers, C-band optical circulators (e.g., New Focus part number 11102p), a telescopic collimator constructed as described herein, a polarizing beamsplitting slab per U.S. patent application Ser. No. 09/537,978, filed on Mar. 28, 2000, as the polarization beam separator, a custom compound zero order quartz half-wave retarder optimized for operation at 1550 nm (e.g., LINOS Photonics part number 36 2703 257), a grism per U.S. patent application Ser. No. 09/537,977, filed on Mar. 28, 2000, as the wavelength dispersive element, a custom doublet lens assembled at Corning GGM from custom optical components procured from LINOS Photonics and other vendors, a linear polarizer made from POLARCOR® material, a custom 1/4.63 wave at 1550 nm zero-order quartz retarder purchased from LINOS Photonics, and a custom reflective LCD as is described in U.S. patent application Ser. No. 10/121453, filed on Apr. 12, 2002, and entitled “High Contrast Reflective LCD for Telecommunications Applications”.

It will become apparent to those skilled in the art that various modifications to the preferred embodiment of the invention as described herein can be made without departing from the spirit or scope of the invention as defined by the appended claims.

The invention claimed is:

1. A multi-fiber optical collimator, comprising:
a plurality of optical fibers for carrying optical signals;
a first lens having first and second sides and a first focal length, wherein the first side of the first lens is positioned a distance of about the first focal length from first ends of the optical fibers; and
a beam expander having first and second sides, wherein the first side of the beam expander is positioned to face the second side of the first lens and the second side of the beam expander provides collimated beams associated with the optical signals carried by the optical fibers.

2. The collimator of claim 1, wherein the beam expander includes:
a second lens having first and second sides and a second focal length, wherein the first side of the second lens is positioned to face the second side of the first lens; and
a third lens having first and second sides and a third focal length, wherein the first side of the third lens is positioned a distance of about the sum of the second and third focal lengths from the second side of the second lens.

3. The collimator of claim 2, wherein the second focal length is about 1.88 mm and the third focal length is about 12.8 mm.

4. The collimator of claim 3, wherein a working distance of the collimator is about 100 mm, an exit pupil beam waist radius of the collimator is about 1.25 mm and an exit pupil beam separation is about 0.54 degrees.

5. The collimator of claim 2, wherein the first, second and third lenses are one of spherical singlet lenses, aspheric singlet lenses, multiple element lenses, spherical mirrors, aspherical mirrors, gradient index (GRIN) lenses, GRADIUM lenses and Mangan mirrors.

6. The collimator of claim 2, wherein the first side of the second lens is positioned a distance of about the first focal length from the second side of the first lens.

7. The collimator of claim 1, wherein the beam expander is a single integrated lens unit with a first side of the integrated lens unit having a first radius and a second side of the integrated lens unit having a second radius.

8. A dual-fiber optical collimator, comprising:
a first and second optical fiber, wherein the first optical fiber has an angled first facet and the second optical fiber has an angled second facet, and wherein the first and second optical fibers are each adapted to carry an optical signal;
a first D-shaped ferrule including a first integral fiber bore for receiving and retaining the first optical fiber;
a second D-shaped ferrule including a second integral fiber bore for receiving and retaining the second optical fiber;
a first lens having first and second sides and a first focal length, wherein the first side of the first lens is positioned a distance of about the first focal length from first ends of the optical fibers; and
a housing shaped for receiving and retaining the first and second D-shaped ferrules and the first lens.

9. The collimator of claim 8, wherein the angled second facet opposes the angled first facet.

10. The collimator of claim 8, wherein the first lens is one of a spherical singlet lenses, an aspheric singlet lenses, a multiple element lenses, a spherical mirrors, an aspherical mirrors, a graded index (GRIN) lenses, a GRADIUM lenses and Mangan mirrors.

11. A method for fabricating a dual-fiber optical collimator, comprising the steps of:
providing first and second optical fibers, wherein the first optical fiber has an angled first facet and the second optical fiber has an angled second facet;
providing a first D-shaped ferrule including a first integral fiber bore for receiving and retaining the first optical fiber;
providing a second D-shaped ferrule including a second integral fiber bore for receiving and retaining the second optical fiber;
providing a first lens having first and second sides and a first focal length, wherein the first side of the first lens is positioned a distance of about the first focal length from first ends of the optical fibers; and
providing a housing for receiving and retaining the first and second D-shaped ferrules and the first lens.

12. The collimator of claim 11, wherein the angled second facet opposes the angled first facet.

13. The collimator of claim 11, wherein the first, second and third lenses are one of spherical singlet lenses, aspheric singlet lenses, multiple element lenses, spherical mirrors, aspherical mirrors, graded index (GRIN) lenses, GRADIUM lenses and Mangan mirrors.

14. A dynamic spectrum equalizer (DSE), comprising:
a plurality of circulators each including at least one input optical fiber, output optical fiber and common optical fiber, wherein each of the input optical fibers is adapted to carry an optical signal;
a telescopic collimator, including:
a plurality of collimator input optical fibers each coupled to one of the common optical fibers;
a first lens having first and second sides and a first focal length, wherein the first side of the first lens is positioned a distance of about the first focal length from first ends of the collimator input optical fibers; and
a beam expander having first and second sides, wherein the first side of the beam expander is positioned to face the second side of the first lens and the second side of the beam expander provides collimated beams associated with the optical signals carried by the input optical fibers;
a polarization beam separator receiving the collimated beams and separating the collimated beams into pairs of polarized beamlets that are substantially orthogonal to each other;
a polarization rotator for rotating the polarity of one of the pairs of polarized beamlets provided by the polarization beam separator;
a dispersive element providing a plurality of sets of beamlets whose propagation directions are dependent upon the beamlets wavelength;
a focusing lens for receiving and directing the plurality of sets of beamlets; and
a reflective spatial light modulator (SLM) for reflecting at least a portion of the beamlets focused onto individual pixels of the SLM by the focusing lens.

15. The DSE of claim 14, wherein the beam expander includes:
a second lens having first and second sides and a second focal length, wherein the first side of the second lens is positioned to face the second side of the first lens; and
a third lens having first and second sides and a third focal length, wherein the first side of the third lens is positioned a distance of about the sum of the second and third focal lengths from the second side of the second lens.

16. The DSE of claim 15, wherein the second focal length is about 1.88 mm and the third focal length is about 12.8 mm.

17. The DSE of claim 16, wherein a working distance of the collimator is about 100 mm, an exit pupil beam waist radius of the collimator is about 1.25 mm and an exit pupil beam separation is about 0.54 degrees.

18. The DSE of claim 15, wherein the first, second and third lenses are one of spherical singlet lenses, aspheric singlet lenses, multiple element lenses, spherical mirrors, aspherical mirrors, gradient index (GRIN) lenses, GRADIUM lenses and Mangan mirrors.

19. The DSE of claim 15, wherein the first side of the second lens is positioned a distance of about the first focal length from the second side of the first lens.

20. The DSE of claim 14, wherein the beam expander is a single integrated lens unit with a first side of the integrated lens unit having a first radius and a second side of the integrated lens unit having a second radius.
